(19) United States
(12) Patent Application Publication
(10) Pub. No.: US 2003/0099398 A1
(43) Pub. Date: May 29, 2003

(54) Character recognition apparatus and character recognition method

(75) Inventor: Yuji Izumi, Kokubunji-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/286,842

(22) Filed: Nov. 4, 2002

(30) Foreign Application Priority Data
Nov. 28, 2001 (JP) 2001-362753

(51) Int. Cl. G06K 9/18

(52) U.S. Cl. 382/186

(57) ABSTRACT

A handwritten character recognition apparatus performs a recognition process for a handwritten input pattern to input character codes. The handwritten character recognition apparatus recognizes a handwritten input pattern as one pictorial symbol formed of a plurality of characters. The plurality of characters are similar in shape to the handwritten input pattern.

### CROSS-REFERENCE TO RELATED APPLICATIONS

This application is based upon and claims the benefit of priority from the prior Japanese Patent Application No. 2001-362753, filed Nov. 28, 2001, the entire contents of which are incorporated herein by reference.

### BACKGROUND OF THE INVENTION

1. Field of the Invention

The present invention relates to a character recognition apparatus and a character recognition method for a pictorial symbol.

2. Description of the Related Art

Generally, there is a limit to characters (a set of characters) usable in a text of e-mail in order to display the characters in the same manner by a variety of electronic mail terminals, mail programs, etc. In order to improve expressive ability of the contents of mail using a text under the limited set of characters, a pictorial symbol made up of a plurality of characters is used. The pictorial symbol includes an emoticon that is also called a smiley or face mark. For example, there are “(ˆ _ˆ )”, “ˆ _ˆ ;” “:-]”, and “T_T” as the emoticon.

Most of the apparatuses having no keyboards for miniaturization, such as a PDA (personal digital assistant) perform a handwritten character recognition process for a handwritten input pattern to input characters. In the handwritten character recognition process, a pictorial symbol is input by sequentially inputting a plurality of characters. For example, in order to input a pictorial symbol “(ˆ _ˆ )”, five characters “(”, “ˆ ”, “_”, “ˆ ”, and “)” have to be input and recognized one by one.

The prior art apparatus has the problem of low input efficiency because when a pictorial symbol made up of a plurality of characters is input, the characters have to be input by hand and recognized one by one.

In most cases, characters that make up a pictorial symbol include ones the number of strokes of which is small, such as a sign and a mark; therefore, they are easy to recognize incorrectly in the handwritten character recognition process. Since, moreover, a pictorial symbol is used in an ordinary text, it is mixed with characters such as hiragana and katakana. In order to distinguish characters that make up a pictorial symbol from hiragana and katakana to prevent them from being recognized incorrectly, a recognition mode exclusively for recognizing only the pictorial symbol needs to be provided. In this case, however, a user has to change the recognition mode each time he or she inputs a pictorial symbol, with the result that an input operation is very complicated and the input efficiency is decreased.

The pictorial symbol can also be input using a kana-kanji transformation method. For example, when a user inputs kana “ [symbol] [symbol] ” (face), he or she performs the kana-kanji transformation and inputs a pictorial symbol made up of a plurality of characters as a result of the transformation.

To input a pictorial symbol by the kana-kanji transformation method, a user has to input a term representing the pictorial symbol by hiragana and then subject it to kana-kanji transformation. In other words, a plurality of hiragana characters have to be input in order to input one pictorial symbol, thus decreasing the input efficiency.

Jpn. Pat. Appln. KOKAI Publication No. 9-34999 discloses a character processing apparatus that separately recognizes a handwritten input pattern as a character and a symbol and inputs a predetermined string of characters based on a combination of character and symbol codes. A correspondence between the handwritten input pattern and input string of characters is determined such that the handwritten input pattern is suggestive of the input string of characters. However, this prior art does not teach a pictorial symbol input.

### BRIEF SUMMARY OF THE INVENTION

An object of the present invention is to provide a character recognition apparatus and method capable of inputting a pictorial symbol made up of a plurality of characters with an improved efficiency.

According to an embodiment of the present invention, there is provided a handwritten character input apparatus comprising a memory which stores reference stroke data and pictorial symbol data corresponding to the reference stroke data; a input unit which inputs stroke data representing a handwritten symbol; and a recognition unit which recognizes the reference stroke data stored in the memory based on the input stroke data so as to output the pictorial symbol data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a system configuration of a PDA having a function of a character recognition apparatus according to an embodiment of the present invention;

FIG. 2 is a schematic view of the structure of a display unit provided on the top of the PDA;

FIGS. 3A and 3B are tables showing in detail a character recognition dictionary and a pictorial symbol recognition dictionary that are stored in a storage unit shown in FIG. 1;

FIG. 4 is a flowchart explaining a handwritten character recognition process for a handwritten character recognition program according to the embodiment of the present invention;

FIG. 5 is an illustration showing an example of a handwritten character pattern;

FIG. 6A is an illustration showing an example of a handwritten pictorial symbol pattern;

FIGS. 6B and 6C are illustrations each showing an example of input strokes of the pattern shown in FIG. 6A;

FIG. 7A is an illustration showing an example of another handwritten pictorial symbol pattern;

FIGS. 7B and 7C are illustrations each showing an example of input strokes of the pattern shown in FIG. 7A;

FIG. 8 is a flowchart explaining registration of data in the pictorial symbol recognition dictionary according to the embodiment of the present invention;

FIG. 9 is an illustration showing an example of a character input screen during the registration of FIG. 8; and

FIG. 10 is an illustration showing an example of a handwritten pattern input screen during the registration of FIG. 8.

### DETAILED DESCRIPTION OF THE INVENTION

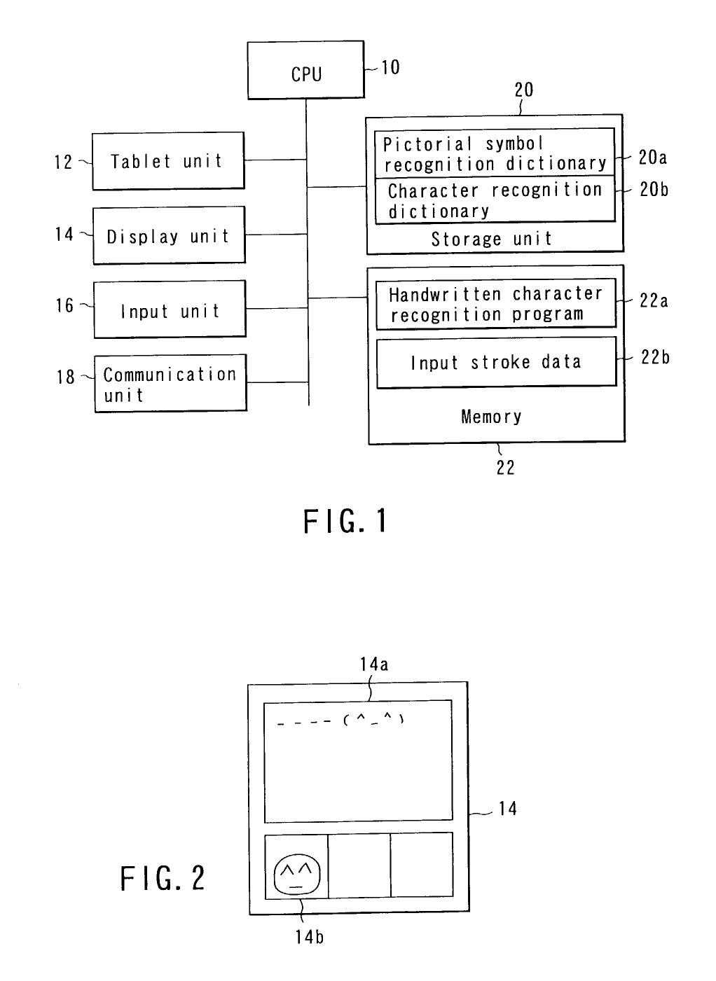

An embodiment of the present invention will now be described with reference to the accompanying drawings. FIG. 1 is a block diagram showing a system configuration of a PDA (personal digital assistant) having a function of a character recognition apparatus according to the embodiment of the present invention. The PDA comprises a CPU 10, a tablet unit 12, a display unit 14, an input unit 16, a communication unit 18, a storage unit 20, and a memory 22.

The CPU 10 controls the whole of the PDA and executes programs stored in the memory 22 to perform various types of processing. The CPU 10 executes a handwritten character recognition program 22a stored in the memory 22 and performs a handwritten character recognition process for input stroke data 22b representing a character or pictorial symbol which is formed of a group of characters written on the tablet unit 12, thereby inputting character codes of the handwritten patterns. The CPU 10 supplies the input character codes to, e.g., a text creating process using a text-creating program.

The tablet unit 12 is designed to detect coordinate data of the handwritten pattern and input the stroke data. A coordinate input surface is formed integrally with a display surface of the display unit 14 in a laminated manner. When a user touches the coordinate input surface with a pen or the like, the tablet unit 12 receives coordinate data of the position. More specifically, when a user writes a character or pictorial symbol pattern on the coordinate input surface with a pen, the tablet unit 12 receives a series of coordinate data (locus data from pen-down to pen-up) representing strokes forming the character or pictorial symbol pattern. The series of coordinate data is stored in the memory 22 as stroke data 22b.

The display unit 14 serves to display various types of information and has a screen for executing various programs stored in the memory 22.

The input unit 16 is used to input data and various instructions and includes various switches and buttons.

The communication unit 18 is connected to an external network to carry out communications under the control of communication programs to be executed by the CPU 10. The communication unit 18 is used to transmit/receive electronic mail.

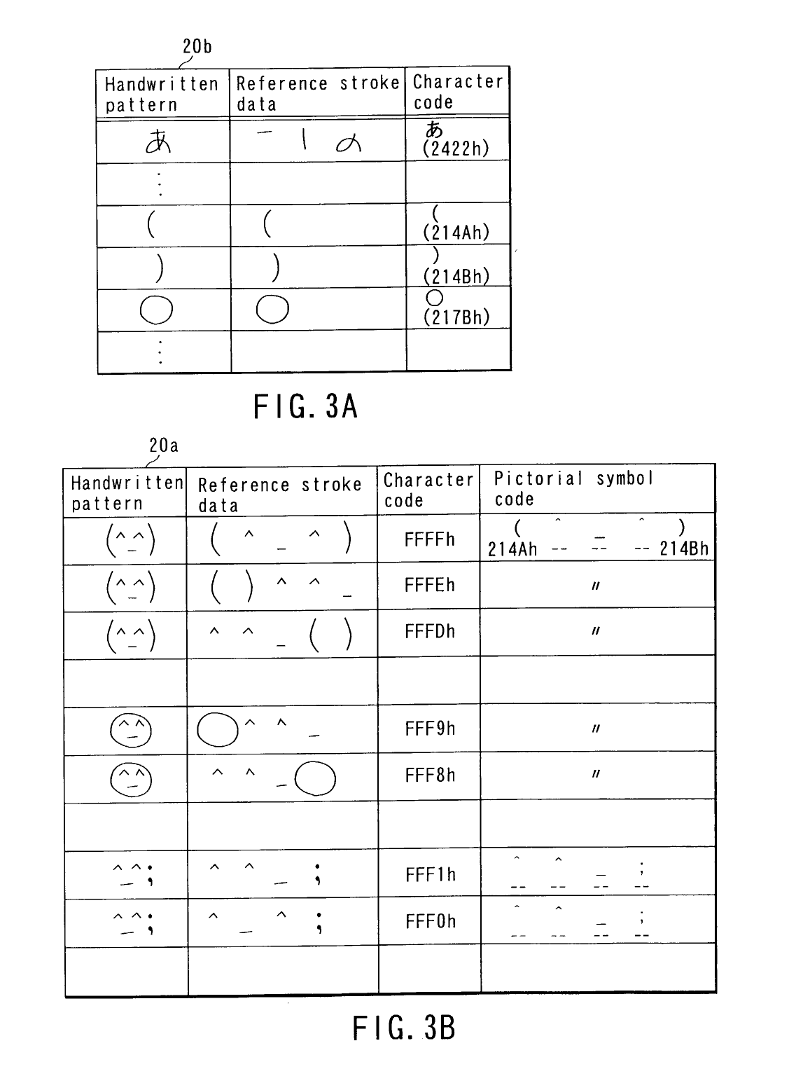

The storage unit 20 is formed of a nonvolatile recording medium such as a hard disk and stores programs, data, etc. The data stored in the storage unit 20 contains a pictorial symbol recognition dictionary 20a and a character recognition dictionary 20b that are used to perform a handwritten character recognition process using the handwritten character recognition program 22a. These dictionaries 20a and 20b will be described in detail later with reference to FIGS. 3A to 3C.

The memory 22 stores programs and data that are read out of a recording medium (not shown) and accessed by the CPU 10 when the need arises. In the embodiment of the present invention, the memory 22 has a work area for temporarily storing work data as well as various programs such as the handwritten character recognition program 22a and text creating programs and various types of data used for executing the programs. The data stored in the memory 22 to execute the handwritten character recognition program 22a contains input stroke data 22b representing a stroke pattern input from the tablet unit 12.

FIG. 2 schematically shows the structure of the display unit 14 provided on the top of a PDA. The display unit 14 includes a main display area 14a for displaying a text formed of results of character recognition and a handwritten pattern input area 14b. If a user writes a character or pictorial symbol in the area 14b with a pen, the handwritten character or pictorial symbol is displayed in a given position of the area 14b. In FIG. 2, the area 14b includes a plurality of (three) regions. The handwritten character recognition process performed by the handwritten character recognition program 22a has the following two cases. In the first case, when the CPU 10 detects that a given time period has elapsed after a pattern is written in one area, it determines that the writing of one character or pictorial symbol is completed. In the second case, when a pattern is written in one area and then another one is written in the next area, the CPU 10 determines that the writing of the one character or pictorial symbol is completed.

The pictorial symbol recognition dictionary 20a and character recognition dictionary 20b that are stored in the storage unit 20 will now be described in detail with reference to FIGS. 3A and 3B.

FIG. 3A shows a structure of the character recognition dictionary 20b. Reference stroke data for recognizing a handwritten pattern and a character code are registered in the dictionary 20b in association with each other for each character. The reference stroke data are objects to be matched with the input stroke data 22b and represents the feature of each of strokes that make up a character. In the handwritten character recognition process, a character code corresponding to the reference stroke data that is determined as one which is the closest to the input stroke data 22b is acquired as a result of recognition (the rate of matching is the highest).

FIG. 3B shows a structure of the pictorial symbol recognition dictionary 20a. A group of reference stroke data for recognizing a handwritten pattern representing a pictorial symbol, a character code (a dummy code), and a pictorial symbol code are registered in the dictionary 20a in association with one another. The pictorial symbol code includes a group of character codes of characters that make up a pictorial symbol. A combination of the characters represented by the group of character codes is similar in shape to the handwritten pattern. A group of reference stroke data are registered in specific order such that a pictorial symbol can be represented by a group of characters in a text. For example, in order to represent a pictorial symbol (emoticon) “(ˆ _ˆ )” in a text, character codes of five characters “(”, “ˆ ”, “_”, “ˆ ”, and “)” are registered in this order.

Further, the reference stroke data of the pictorial symbol recognition dictionary 20a are so configured that a handwritten input pattern representing one pictorial symbol can be recognized irrespective of the input order of strokes that make up the pictorial symbol. For example, a handwritten input pattern representing a pictorial symbol “(ˆ _ˆ )” can be recognized if strokes that make up the pictorial symbol are input in any one of a first order “(”, “ˆ ”, “_”, “ˆ ”, and “)”, a second order “(”, “)”, “ˆ ”, “ˆ ”, and “_”, and a third order “ˆ ”, “ˆ ”, “_”, “(”, and “)”. Consequently, even though strokes that make up a handwritten input pattern are input in any order using the pictorial symbol recognition dictionary 20a in the handwritten character recognition process, a pictorial symbol code can be obtained.

The pictorial symbol recognition dictionary 20a shown in FIG. 3B contains a character code that corresponds to the pictorial symbol code and is not used in the character recognition dictionary 20b. The character codes start from “FF” are not used in the character recognition dictionary 20b. In order to recognize a pictorial symbol, only a pictorial symbol code is finally necessary; therefore, no character codes are not necessary to be registered in the pictorial symbol recognition dictionary 20a.

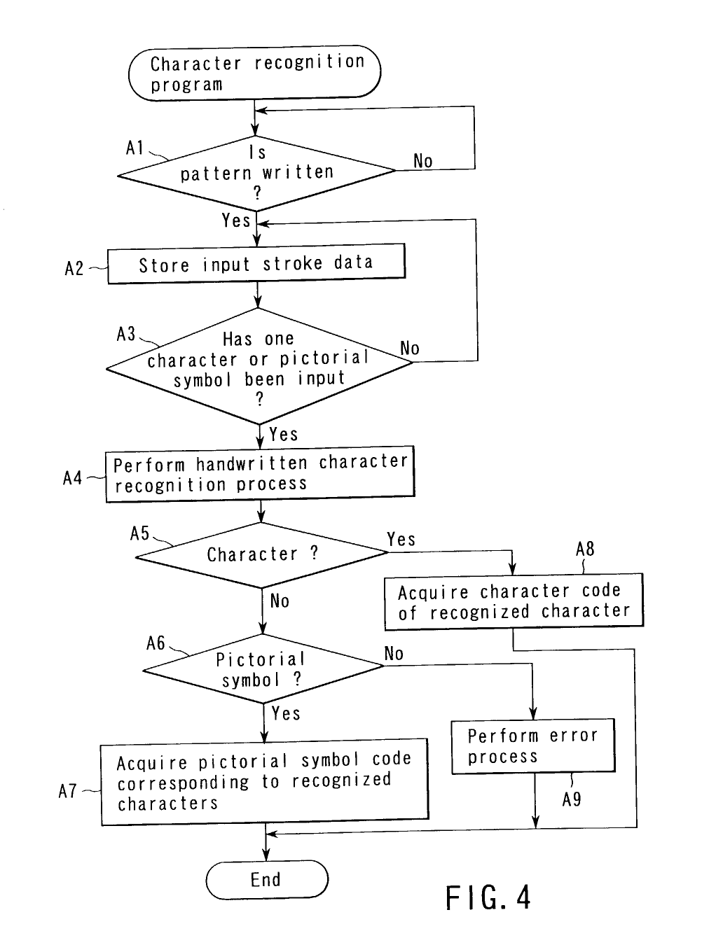

The handwritten character recognition process that is performed by the handwritten character recognition program 22a will now be described with reference to the flowchart shown in FIG. 4.

Upon receiving an instruction to input characters by hand through the input unit 16, the CPU 10 starts the handwritten character recognition program 22a to perform a handwritten character recognition process. For example, when the CPU 10 receives an instruction to perform a text creating process, it starts the handwritten character recognition program 22a together with the text-creating program.

The CPU 10 monitors whether a coordinate data row representing strokes of a handwritten pattern is input through the tablet unit 12 when a user writes the pattern in the handwritten character input area 14b with a pen or the like. The CPU 10 determines that the pattern is written when the coordinate data row is input through the tablet unit 12 (step A1). The CPU 10 stores the input coordinate data row in the memory 22 as input stroke data 22b and displays a handwritten pattern on the handwritten character input area 14b based on the handwritten input pattern data 22b (step A2).

If the CPU 10 determines that strokes for one character or pictorial symbol have been written in one area of the handwritten character input area 14b (step A3), it performs a handwritten character recognition process for the input stroke data 22b using the pictorial symbol recognition dictionary 20a and character recognition dictionary 20b (step A4).

If the CPU 10 recognizes the input stroke data by using the reference stroke data registered in the dictionary 20b (step A5), it inputs a character code of the recognized character (step A8). The CPU 10 supplies the input character code to a text creating process and displays the character on the main display area 14a of the display unit 14.

If the CPU 10 recognizes the input stroke data by using the reference stroke data registered in the dictionary 20a (step A6), it acquires a pictorial symbol code formed of a group of recognized character codes in the order of registration in the dictionary 20a (step A7). In other words, the CPU 10 acquires character codes of a group of characters forming a pictorial symbol that is similar in shape to a handwritten pattern in the order in which the pictorial symbol can be represented in a text. The CPU 10 supplies the input character codes to a text creating process and displays the characters suggestive of the handwritten pattern on the main display area 14a of the display unit 14. As a result, the pictorial symbol (emoticon) made up of the characters is included in the text.

When an appropriate recognition result is obtained from neither of the dictionaries 20a and 20b (step A6), the CPU 10 performs a given error process (step A9).

Specific examples of a handwritten input pattern will now be described.

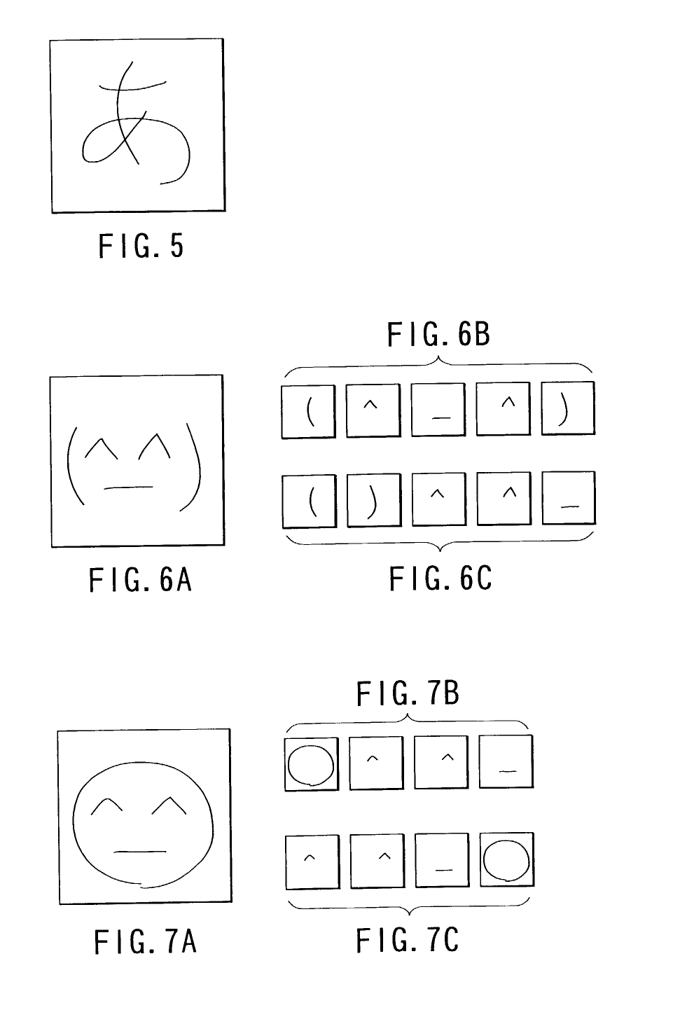

When a character of hiragana “ [symbol] ” is written as shown in FIG. 5, a character code “2422h” of character “ [symbol] ” is obtained by the handwritten character recognition process based on the reference stroke data registered in the character recognition dictionary 20b. For example, two-byte character code is obtained for one character “ [symbol] ”.

When an emoticon “(ˆ _ˆ )” is written as shown in FIG. 6A, a character code FFFFh is selected by the handwritten character recognition process based on the reference stroke data registered in the pictorial symbol recognition dictionary 20a. A pictorial symbol code corresponding to the selected character code FFFFh is obtained. In other words, five character codes for “(”, “ˆ ”, “_”, and “)” are obtained in this order.

The reference stroke data as shown in FIG. 3B is registered in the pictorial symbol recognition dictionary 20a such that the handwritten pattern shown in FIG. 6A can be recognized even though the strokes are input in either of the orders shown in FIGS. 6B and 6C, i.e., “(”, “ˆ ”, “_”, “ˆ ”, and “)” and “(”, “)”, “ˆ ”, “ˆ ”, and “_”. If, therefore, a user writes a pattern representing a pictorial symbol by hand in arbitrary stroke order without being conscious of the input order of a plurality of finally-input characters, he or she can input the characters representing the pictorial symbol to a text.

When a handwritten pattern similar to emoticon “ ” similar to the emoticon “(ˆ _ˆ )” is written as shown in FIG. 7A, a character code FFF9h is selected by the handwritten character recognition process based on the reference stroke data registered in the pictorial symbol recognition dictionary 20a. A pictorial symbol code corresponding to the selected character code FFF9h is obtained in the same manner as described above. The pictorial symbol shown in FIG. 7A is recognized like that shown in FIG. 6A. Five character codes of “(”, “ˆ ”, “_”, “ˆ ”, and “)” are registered in the dictionary 20a as a pictorial symbol code as shown in FIG. 3B. If, therefore, a user write a pattern representing a single pictorial symbol by hand without being conscious of a plurality of finally-input characters, he or she can input the characters, which make up a pictorial symbol similar to the handwritten pattern registered in the dictionary 20a, to a text.

A user can input a pictorial symbol code by writing a pattern representing a pictorial symbol through the handwritten character recognition process. In most cases, a pictorial symbol is formed of a plurality of characters include simple ones, such as “(”, “ˆ ”, “_”, “ˆ ” and “)”, which are easy to be recognized incorrectly because their strokes are small in number. However, according to the present embodiment, but characters making up a pictorial symbol are recognized as one symbol. Therefore, as compared with the case where characters that make up a pictorial symbol are input and recognized one by one, the accuracy of recognition is improved. An operator need not repeatedly input incorrectly-recognized characters to correct the characters, thereby improving the efficiency of input and performing an operation of inputting a text including a pictorial symbol in short time. Even though the operator is not aware of a plurality of characters that make up a pictorial symbol to be input to a text or the order of the characters, he or she can input the plurality of characters in correct order if he or she inputs strokes representing the pictorial symbol by hand in arbitrary order.

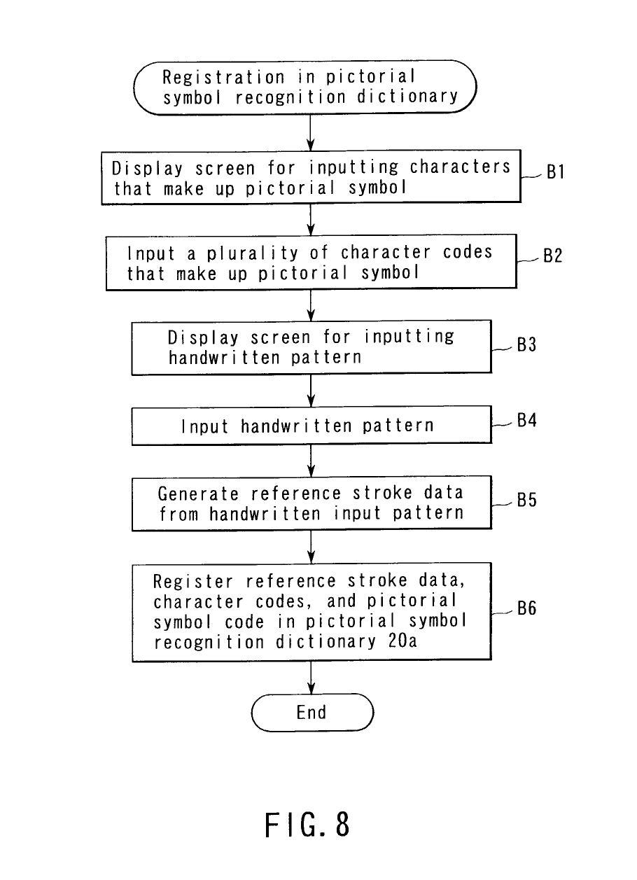

The registration of data in the pictorial symbol recognition dictionary 20a used for the handwritten character recognition process will now be described with reference to the flowchart shown in FIG. 8.

Upon receiving an instruction to register data in the dictionary 20a, the CPU 10 shifts to a data registration mode using the handwritten character recognition program 22a and starts the process according to the flowchart shown in FIG. 8.

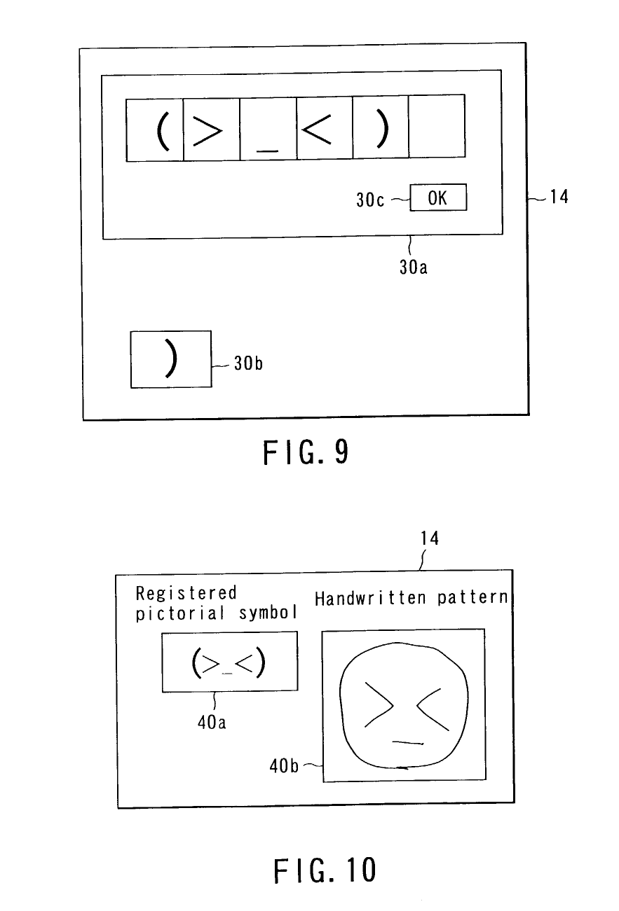

First, the CPU 10 causes the display unit 14 to display a character input area 30b and registered pictorial symbol display area 30a in order to input a pictorial symbol code formed of a plurality of character codes (step B1). When the characters that make up a pictorial symbol are written in the character input area 30b one by one, a character recognition is performed and the recognized characters making up the pictorial symbol are displayed in the pictorial symbol display area 30a, as shown in FIG. 9 (step B2). In FIG. 9, characters “(”, “>”, “_”, “<”, and “)” that make up a pictorial symbol “(>_<)” are displayed.

If the character recognition is correctly performed, i.e., a desired combination of characters are displayed user depresses an “OK” button 30c. Then the CPU 10 causes, as shown in FIG. 10, the display unit 14 to display a handwritten pattern input area 40b for inputting a handwritten input pattern corresponding to the registered pictorial symbol shown in an area 40a (step B3). Then, the CPU 10 inputs the handwritten input pattern through the handwritten pattern input area 40b (step B4).

When a handwritten pattern is written in the handwritten pattern input area 40b, the CPU 10 generates reference stroke data, which is to be used in the handwritten character recognition process, based on the handwritten input pattern (step B5). In other words, the feature of each of strokes that make up the handwritten input pattern is extracted and converted into a data format that can be compared with the handwritten input pattern data.

The CPU 10 registers the reference stroke data, which is generated from the handwritten pattern input through the handwritten pattern input area 40b, a character code different from character codes of normal characters in the pictorial symbol recognition dictionary 20a in association with each other. Further, the CPU 10 registers character codes of the plurality of characters input through the character input area 30b in the dictionary 20a in input order as a pictorial symbol code in association with the pattern recognition data and the character code (step B6).

The foregoing embodiment has been described, provided that one handwritten input pattern is registered. A plurality of handwritten input patterns can be registered to generate reference stroke data based thereon. Recognizable reference stroke data can thus be generated even though a handwritten input pattern varies when the handwritten character recognition process is performed. Even when one handwritten input pattern is input, a plurality of handwritten input patterns can automatically be generated based on the input handwritten input pattern and reference stroke data can be generated based on the automatically generated handwritten input patterns. For example, the plurality of handwritten input patterns are automatically generated by varying the order of input strokes or slightly varying the shape of a stroke.

As described above, a pictorial symbol made up of a plurality of characters and a handwritten input pattern to be input by hand when the pictorial symbol is input to a text can arbitrarily be registered in the pictorial symbol recognition dictionary 20a. Consequently, a plurality of characters can freely be combined into a pictorial symbol and the pictorial symbol can easily be used in a text if the arbitrarily registered handwritten input pattern is input by hand.

The foregoing embodiment has been described, provided that a pictorial symbol code string, which is input as a result of recognition of a handwritten input pattern representing a pictorial symbol, is registered in the pictorial symbol recognition dictionary 20a in association with reference stroke data and character codes. However, the pictorial symbol recognition dictionary 20a can be prepared as a database other than a dictionary for recognizing handwritten characters. In this case, when character codes representing a pictorial symbol are acquired through the handwritten character recognition process, a pictorial symbol code is retrieved and acquired from the database based on the character codes.

The foregoing embodiment is directed to emoticon as a pictorial symbol. However, the pictorial symbol need not always represent a face if is made up of a plurality of characters.

In the foregoing embodiment, the handwritten character input apparatus is achieved in a PDA. However, it can be done in any apparatus.

According to the method in the foregoing embodiment, handwritten character recognition programs that can be executed by a computer can be written to a recording medium such as a magnetic disk (a flexible disk, a hard disk, etc.), an optical disk (a CD-ROM, a DVD, etc.), and a semiconductor memory and provided to various types of apparatus. Also, the programs can be transmitted by a communications medium and provided to various types of apparatus. The computer that realizes the apparatus of the present invention performs the foregoing process by reading programs from a recording medium or receiving programs through a communications medium and controlling an operation based on the programs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A character recognition apparatus comprising:
a memory which stores reference stroke data and pictorial symbol data corresponding to the reference stroke data;
a input unit which inputs stroke data representing a handwritten symbol; and
a recognition unit which recognizes the reference stroke data stored in the memory based on the input stroke data so as to output the pictorial symbol data.

2. The character recognition apparatus according to claim 1, wherein the recognition unit outputs the pictorial symbol data one by one.

3. The character recognition apparatus according to claim 1, wherein the memory stores reference stroke data representing an emoticon and pictorial symbol data corresponding to the reference stroke data.

4. The character recognition apparatus according to claim 1, further comprising a registration unit which writes into the memory a new reference stroke data and a new pictorial symbol data.

5. The character recognition apparatus according to claim 1, wherein the memory stores a first pair of a first group of reference stroke data representing a first pictorial symbol and a first group of pictorial symbol data corresponding to the first group of reference stroke data and a second pair of a second group of reference stroke data representing the first pictorial symbol and the first group of pictorial symbol data corresponding to the second group of reference stroke data.

6. The character recognition apparatus according to claim 5, wherein the first group of reference stroke data includes stroke data of plural strokes in a first order and the second group of reference stroke data includes the stroke data of the plural strokes in a second order.

7. The character recognition apparatus according to claim 1, wherein the memory stores a first pair of first group of reference stroke data representing a first pictorial symbol and a first group of pictorial symbol data corresponding to the first group of reference stroke data and a second pair of a second group of reference stroke data representing a second pictorial symbol and the first group of pictorial symbol data.

8. A character recognition apparatus comprising:
a first memory which stores reference stroke data representing a character and a character code corresponding to the reference stroke data;
a second memory which stores reference stroke data representing a pictorial symbol and character codes corresponding to the reference stroke data, wherein characters corresponding to the character codes show a shape of the pictorial symbol;
a input unit which inputs stroke data representing a handwritten pattern; and
a recognition unit which performs a first recognition processing for the input stroke data by using the first memory, performs a second recognition processing for the input stroke data by using the second memory.

9. The character recognition apparatus according to claim 8, wherein the second memory stores reference stroke data representing an emoticon and character codes corresponding to the reference stroke data.

10. The character recognition apparatus according to claim 8, further comprising a registration unit which writes into the second memory a new reference stroke data and new character codes.

11. The character recognition apparatus according to claim 8, wherein the second memory stores a first pair of a first group of reference stroke data representing a first pictorial symbol and a group of character codes corresponding to the first group of reference stroke data and a second pair of a second group of reference stroke data representing the first pictorial symbol and the first group of character codes corresponding to the second group of reference stroke data.

12. The character recognition apparatus according to claim 11, wherein the first group of reference stroke data includes stroke data of plural strokes in a first order and the second group of reference stroke data includes the stroke data of the plural strokes in a second order.

13. The character recognition apparatus according to claim 8, wherein the second stores a first pair of first group of reference stroke data representing a first pictorial symbol and a first group of character codes corresponding to the first group of reference stroke data and a second pair of a second group of reference stroke data representing a second pictorial symbol and the first group of character codes.

14. A character recognition method comprising:
inputting stroke data representing a handwritten symbol; and
recognizing, based on the input stroke data, one of character codes stored in a memory which stores reference stroke data representing a pictorial symbol and character codes corresponding to the reference stroke data, wherein characters corresponding to the character codes show a shape of the pictorial symbol.

15. The method according to claim 14, wherein the recognizing the one of the character codes comprising recognizing the character codes one by one.

16. The method according to claim 14, wherein the inputting the stroke data comprising inputting the stroke data in a different order.

17. A character recognition method comprising:
inputting stroke data representing a handwritten pattern; and
performing a first recognition processing for the input stroke data by using a first memory which stores reference stroke data representing a character and a character code corresponding to the reference stroke data and a second recognition processing for the input stroke data by using a second memory which stores reference stroke data representing a pictorial symbol and character codes corresponding to the group of the reference stroke data, wherein characters corresponding to the character codes show a shape of the pictorial symbol.

18. The method according to claim 17, wherein the second recognition processing obtains a group of character codes corresponding to the handwritten pattern and the inputting one of the results of the first recognition processing and the second recognition processing comprising inputting the obtained group of character codes one by one.

19. The method according to claim 17, wherein the inputting the stroke data comprising inputting the stroke data in a different order.
